(19) United States
(12) Patent Application Publication
(10) Pub. No.: US 2007/0024019 A1
(43) Pub. Date: Feb. 1, 2007

(54) Step scooter

(76) Inventors: Kenneth A. Tarlow, Corte Madera, CA (US); James Allan Douglas, New York, NY (US)

Correspondence Address: KENNETH A. TARLOW, 21 GOLDEN HIND PASSAGE, CORTE MADERA, CA, 94925, US

(21) Appl. No.: 11/193,135

(22) Filed: Aug. 1, 2005

(51) Int. Cl. B62M 1/00

(52) U.S. Cl. 280/221

(57) ABSTRACT

Step Scooter with a longitudinal support bar, a twelve inch wheel assembly attached to the back end of the longitudinal bar, a six inch wheel and steerable front fork at the front end of the longitudinal bar, a handle bar and support tube, an eight and one half inch diameter crank gear attached by a shaft to the longitudinal support bar, a two and one half inch diameter back wheel gear, a drive chain attaching the small gear to the large gear, a left and right drive disk each having a shaft protruding outwardly from near the perimeter of the disk, a pair of step support bars including step platforms, each attached to the perimeter disk shaft, the end of each step support bar terminating in a roller wheel and corresponding tracks for each roller wheel to travel in.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of foot powered scooters and more specifically to a step scooter.

Foot powered scooters of one sort or another have been manufactured and used by people of all ages for many years. Generally, a scooter consists of a horizontal platform having a U shaped bracket at the rear end that supports a rear wheel and a steerable front fork assembly at the front end that supports a front wheel. A relatively vertical support tube extends upward from the front fork and a handle bar assembly is attached to the top of the support tube. The user generally places one foot on the horizontal platform, places his or her hands on the handle bars and pushes away on the ground with the other foot thereby propelling the user forward. The user can place both feet on the horizontal platform while coasting on the scooter.

Foot powered scooters have been designed and manufactured in many styles. Some scooters are made to be used in rugged conditions and include pneumatic tires and hand brakes such as the California Know-Ped or a series of scooters made by Sidewalker USA including the Micro which has a folding handle. More recently, the Razor Scooters have been very popular with children and young adults. In an effort to combine some of the advantages of a bicycle with a scooter, Dean Janssen in his patent U.S. Pat. No. 6,773,022 discloses a bicycle for producing stair stepping exercise motion that includes an elliptical stepping mechanism to help drive the bike forward. The elliptical stepping motion is well known in stationary exercise devices. Pedro Cabal, in his patent U.S. Pat. No. 6,648,353 also discloses an elliptical stepping action in relation to a bicycle.

However, the two patents sited have certain deficiencies with respect to the design of an ideal step scooter. The Janssen patent discloses a pair of stepping platforms that are each attached to a crank portion at the back end and slidably attached to the horizontal frame at the front end. This configuration means that the user's foot is quite seriously angled at the top of the stroke creating a potentially dangerous stepping action. Additionally, there is no real thought given to the compactness and portability of the scooter for use during times of transport or storage. There are no dimensional claims as to what would make the most effective, fastest step scooter that would also form the smallest possible package during non use periods. For a scooter to be truly useful, especially for an adult, it must be able to become small enough and easy enough to carry during non use that it can be stored in the trunk of a vehicle or can be carried onto public transportation such as a bus, train or ferry. Both Janssen and Cabal refer to their inventions as bicycles. This is a clear indication that they have not designed these inventions with the compact qualities of a scooter in mind. Additionally, my experiments have shown that the distance the two stepping platforms is critical in that the further apart the stepping platforms are, the more difficult it is to start the stepping action. When a user balances on one step during the initial start, the ability to keep the scooter upright is strained. The closer together the two steps are, the easier it is to maintain balance during the start of a ride. Neither Janssen nor Cabal have addressed this problem. I have also found that there is an ideal combination of wheel size and gear size for a scooter to perform at speeds similar to a bicycle and yet be able to fold down the the most compact form during transport and storage. Neither Janssen nor Cabal have addressed this crucial issue. Finally, no prior art that I have found addresses the possibility of converting a step scooter into a stationary elliptical exercise device.

### BRIEF SUMMARY OF THE INVENTION

The primary object of the invention is to provide a unique scooter that can be propelled by an elliptical stepping action.

Another object of the invention is to provide a step scooter that is designed for minimum size for compact for easy transport

Another object of the invention is to provide a step scooter that has an ideal gearing system to propel a user at bicycle type speeds.

A further object of the invention is to provide a step scooter that keeps the users feet relatively level with respect to the ground.

Another object of the invention is to provide a step scooter where the distance between the stepping platforms is relatively small and the platforms themselves are close to the center of gravity, thereby making it easier and safer to begin riding the scooter.

Yet another object of the invention is to provide a step scooter that includes a carry handle for easy transport.

Still yet another object of the invention is to provide a step scooter that includes an optional stand that allows the scooter to be used as a stationary exercise machine.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a step scooter comprising: a longitudinal support bar, a twelve inch diameter resileint wheel attached by a shaft to a U shaped bracket at one end of said longitudinal bar, a six inch diameter resilient wheel attached to by a shaft to a steerable front fork at the opposite end of said longitudinal bar, a hinged handle bar support tube, a handle bar attached to said support tube, a large approximately eight and one half inch diameter drive gear attached by a shaft to said longitudinal support bar, a small approximately two and one half inch diameter gear attached to said shaft of said twelve inch wheel, a drive chain attaching said small gear to said large gear, a left and right drive disk, each centrally attached to said large gear shaft, each said disk having a shaft protruding outwardly from near the perimeter of said disk, a pair of step support bars, each rotatably attached to said perimeter disk shaft, the end of said step support bar terminating in a roller wheel, a corresponding track for each said roller wheel to travel in and a pair of step platforms attached to said step support bars.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side view of the invention in use.

FIG. 2 is a partial side view of the drive mechanism of the invention

FIG. 3 is a top view of the invention.

FIG. 4 is a side view of the invention in the folded transport position.

FIG. 5 is a front view of the handle bar assembly.

FIG. 6 is a side view of the invention with a storage bag in place.

FIG. 7 is a side view of the invention with a stationary exercise module in place.

FIG. 8 is a top section view of the stationary exercise module.

FIG. 9 is a side view diagram of the stepping positions.

FIG. 10 is a side view diagram of the maximum up and down stepping positions.

FIG. 11 is a side view of the invention in a storage box.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

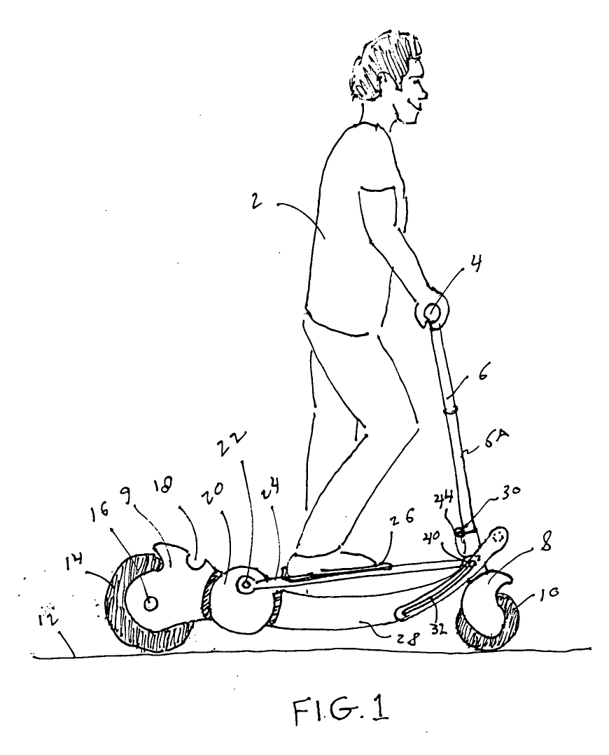

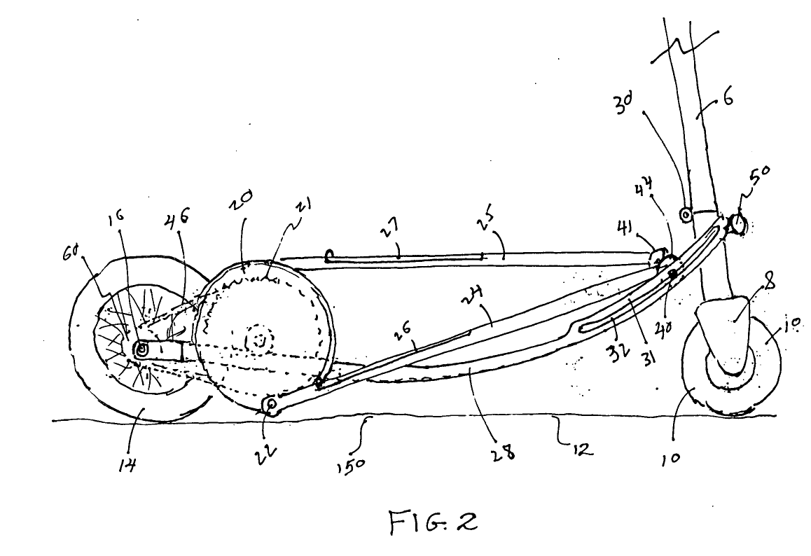

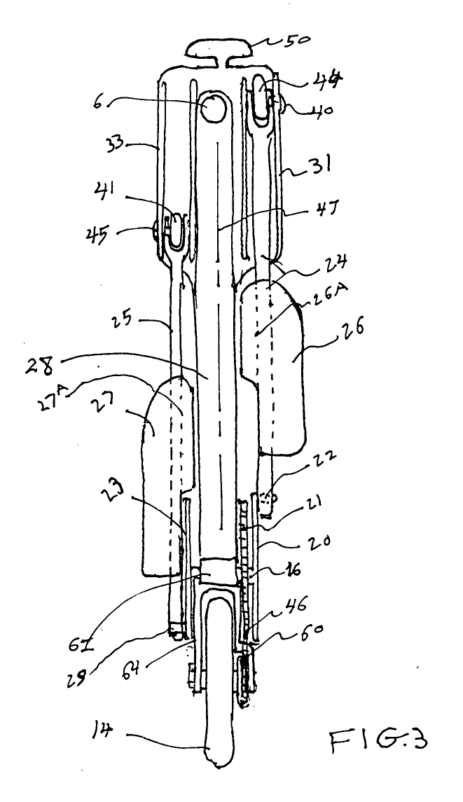

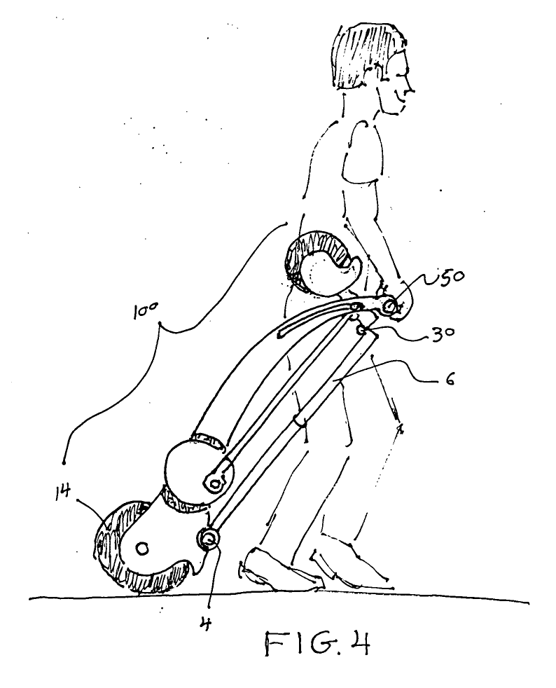

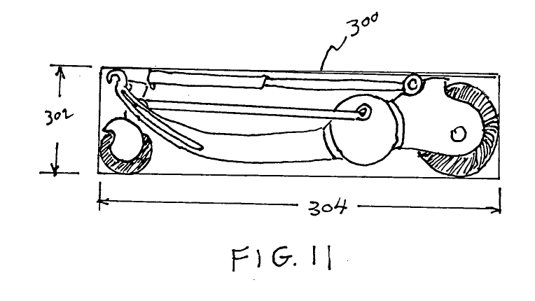

Referring now to FIG. 1 we see a side view of the step scooter of the present invention. The user 2 is standing on step platforms 26 and 27. Twelve inch diameter resilient rear wheel 14 is attached longitudinal bar 28 by hollow shaft 16. Steerable six inch diameter resilient front wheel 10 is attached to the front of longitudinal bar 28. Hinged 44 handle bar post 6 rises from steerable front fork and terminates in handle bar 4. Handle bar support post 6 is telescoping 6A so that the user can adjust the height of the post 6 and so that the post can be adjusted when folded down allowing handle bar portion 4 to reside in cradle portion 18 as shown in FIG. 4. All structural parts of the scooter are made of rigid materials such as steel, aluminum, titanium, or carbon fiber. Drive disk 20 replaces a standard crank found on most bicycles. Although a standard bicycle crank assemble could work, the disk 20 allows for close proximity of step bar 24 to the disk 20 and prevents the user's foot from becoming entangled in the crank mechanism. Step bar 24 is pivitally connected to drive disk shaft 22 at one end and to a rolling wheel 44 at the opposite end. The shaft of rolling wheel 40 protrudes through slot 32 thereby preventing the wheel 44 and attached step bar from disengaging from its designated area. Outer covering 8 of front wheel 10 and outer rear wheel cowl 9 reduces the chance of upward splashing of rain water. Additionally, the outer covering reduces the chance of the user becoming soiled by potentially dirty mechanical parts while riding or while carrying the scooter during non use as shown in FIG. 4. FIG. 2 shows a side view of the invention with the outer housing removed. Drive sprocket 21 is shown as a dotted line drawing and resides just behind drive disk 20. Sprocket 21 is approximately eight and one half inches in diameter. Rear wheel sprocket 60 is approximately two and one half inches in diameter. Both sprockets are connected by drive chain 46. The diameters of the drive sprockets are important because if drive sprocket 21 is any smaller, it reduces the overall speed of the scooter when in use. If sprocket 21 were any larger, it would be in danger of striking the ground during use. To obtain speeds that a normal bicycle can reach, it is necessary to have sprocket 21 be as large as possible within the design constraints imposed by the size of rear wheel 14 and the need to create the smallest package when in the stored position as shown in FIG. 11 where the entire scooter can fit within the confines of box 300. The scooter is approximately forty-eight inches long as shown by dimension line 304 by thirteen inches tall as shown by dimension line 302 by approximately eleven inches wide. These dimensions are critical when considering storage of the unit within a standard vehicle trunk. In this way, the scooter can be stored in a vehicle trunk while traveling to a bus or train terminal, then taken onto a bus, train or ferry in the folded position as shown in FIG. 4, then unfolded and used in a city environment in a designated bike lane. Storage of the scooter in an office environment is also much more convenient than storing a bicycle. Storing the scooter off the street reduces the chance of theft. Obviously, the front wheel 10 must be small, approximately six inches in diameter, to fit within the confines dictated by box 300 shown in FIG. 11. Although front wheel 10 is relatively small, I have found that a pneumatic wheel of this size is acceptable with regard to shock during normal riding conditions and even works adequately for off road conditions. FIG. 3 shows a top view of the scooter of the present invention. Step platforms 26, 27 are firmly attached to longitudinal step bars 24, 25. The front portions of the steps 26A, 27A extend inwards towards center longitudinal bar 28. In this way, when a person starts riding the scooter, he or she can place their feet in close proximity to the center of gravity line as shown by dashed line 47. My experiments have shown that this configuration is very important when a person is just starting out and has only one foot on a pedal as he or she starts the forward motion of the scooter as done in conventional scooter riding. After attaining sufficient speed, the user can move his or her feet to the rear of the step platforms 26, 27 for a more ergonomically correct long term use position. Standard bearing retaining assembly 62 holds shaft 16 and attached drive gear 21 and drive disks 20, 23. Outwardly protruding shafts 22, 29 are pivot points that hold step bars 24, 25. A U shaped portion at the front of step bars 24, 25 hold roller wheels 41, 44 within tracks 31, 33. The compact configuration of all drive parts allow for a relatively small overall width of approximately eleven inches from the left side of step 27 to the right side of step 26. Handle 50 allows for easy transport and shown by FIG. 4.

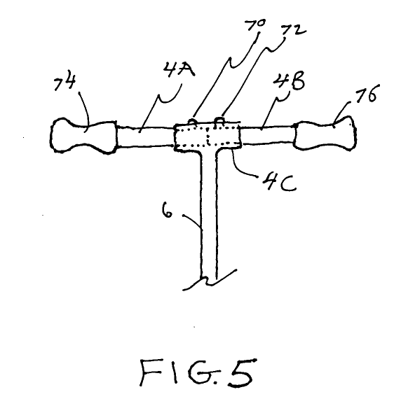

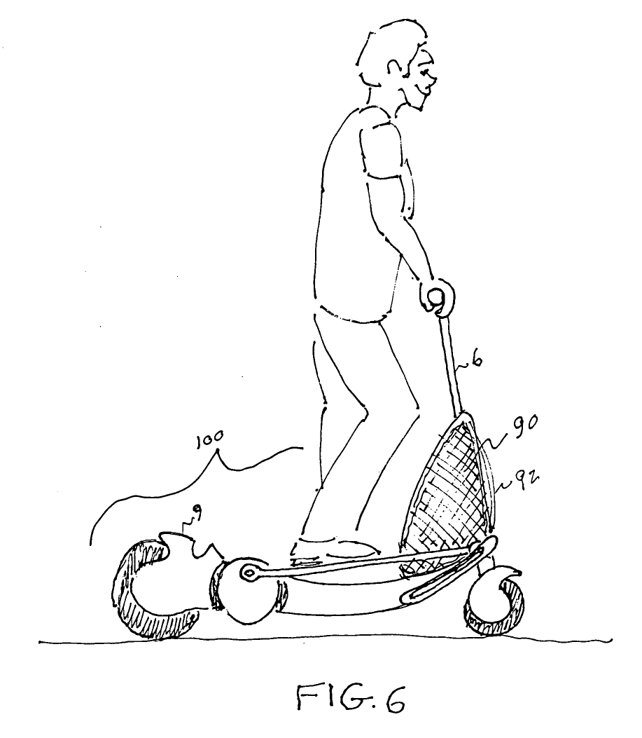

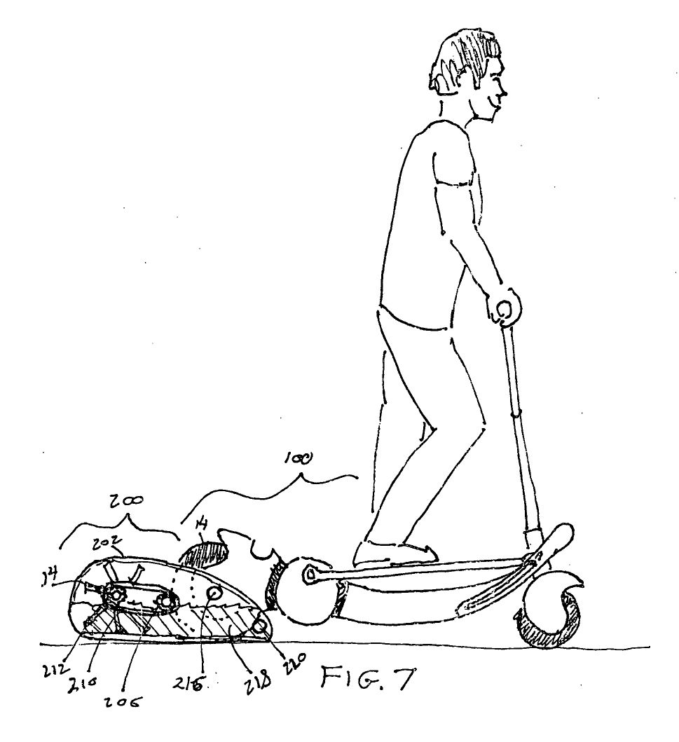

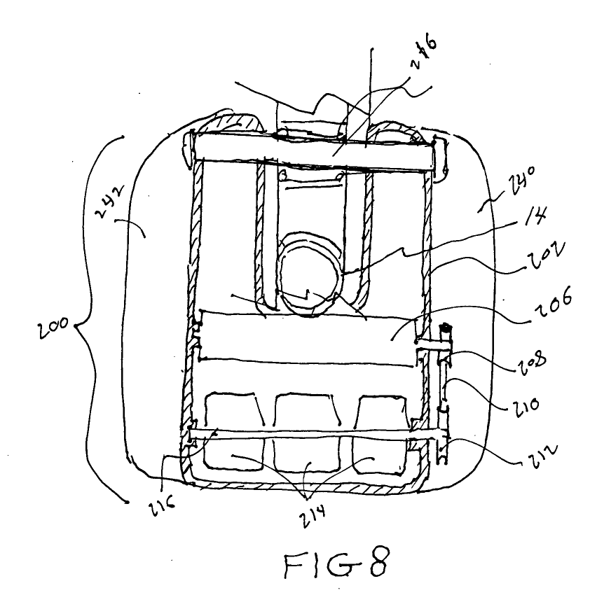

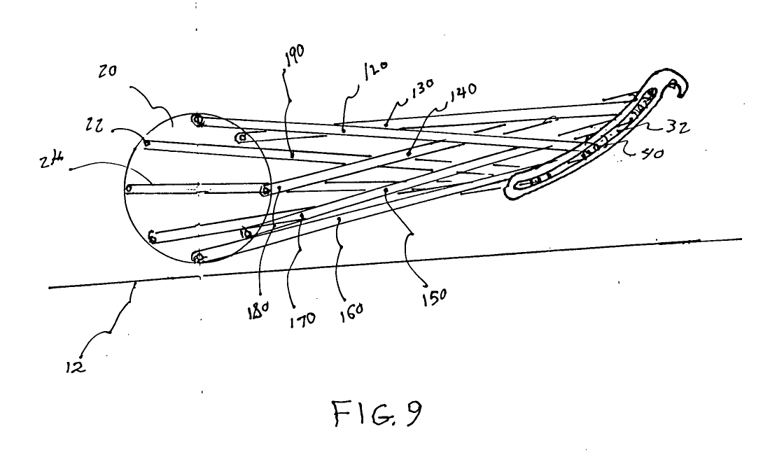

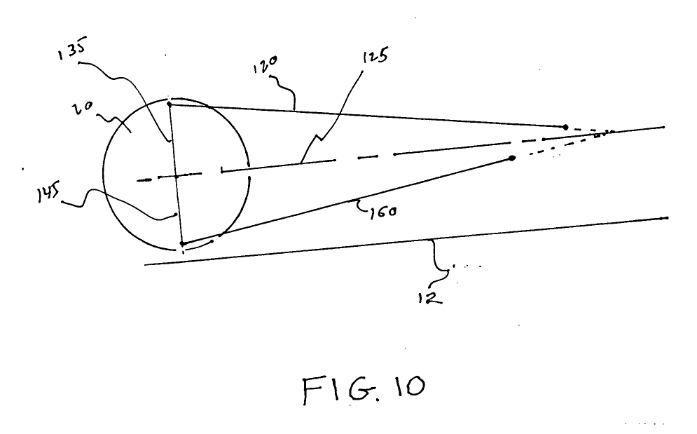

Referring now to FIGS. 9 and 10 we see the various angles of the step bar 24 as drive wheel 20 makes one revolution. As discussed earlier, step bar 24 is attached at one side to pivot shaft 22 and at the other side to shaft and wheel 40. Points 120, 130, 140, 150, 160, 170, 180, 190, indicate an identical point on the step at each of eight locations that form an elliptical pattern during the step cycle. FIG. 10 shows that the maximum high point 120 and maximum low point 160 are equidistant from the central line 125 that is parallel to the ground plane 12 as defined by dimension lines 135, 145. This configuration equally splits the flexion activity of the user's foot between slightly up and slightly down with relation to the ground plane 12. This configuration provides optimal exercise for the users calf and foot muscles without overly extending the Achilles tendon during the down stroke. The maximum angle during the up position 120 is small enough that use in this position does not create discomfort which a greater angle can engender. FIG. 5 shows a partial front view of the handle bar assembly where a hollow T fitting at the top of support tube 6 can accept left handle bar portion 4A and right handle bar portion 4B. Spring retaining buttons 70, 72 allow the handles to be easily removed and replaced. In this way, during non use periods, the user can fold down support tube 6 and remove the handle bars 4A 4B to create the most compact storage and carrying conditions. FIG. 6 shows the scooter of the present invention 100 with a storage pack 90 attached. The pack is designed for removal and for use as a conventional back pack by use of pack straps 92. A recess is cut out of the front portion of the pack to allow it to wrap around support tube 6. Obviously, a pack or basket could also be attached to the rear cowl portion 9. Other obvious features have not been illustrated because of there common nature, such as hand operated brakes, rear view mirrors and head lights or tail lights. Not so obvious is the possible inclusion of a three speed internal gear changing hub such as one made by Sturmey Archer. This type of hub would allow a user to change gears when going up a hill, however would not take up additional lateral space as would a conventional external gear cluster. FIG. 7 shows the use of the scooter 100 as a stationary exercise machine. A rear wheel stand assembly 200 is attached to the rear wheel 14 by a cross shaft that goes through an aperture 60 at the center of the wheel 14 hub. The positioning of the shaft 216 is such that it holds the wheel 14 slightly off the ground. Additional support us gained by the use of free wheeling roller 220. A secondary roller 206 also frictionally engages rear wheel 14. The roller 206 includes an outwardly extending shaft and pulley 208 as shown in FIG. 8. drive belt 210 engages paddle wheel pulley 212 and shaft 216 so that the rotating action of roller 206 causes paddle wheel 214 to spin. Housing 202 is able to retain water or other liquid 218 that provides resistance to paddle wheel 214. This resistance simulates typical road resistance encountered during scooter riding. Therefore, a person can obtain exercise results in a stationary position similar to those obtained in a motion riding condition. Obviously, other known resistance means can be employed such as electromagnetic resistance or frictional mechanical resistance. Additionally, the rear wheel 14 can be supported on assembly 200 in other ways such as the normal attachment means found on most bicycle frames. extension flanges 240, 242 act to stabilize the unit 200 so that the attach scooter 100 remains upright.

The above described and illustrated scooter provides an excellent way for a person of any age to travel without the need for auxiliary power such as gasoline or electricity and without the need for traditional push away foot motion associated with human powered scooters The compact nature of the design allows it to be easily taken and stored in a vehicle and carried onto a train, bus or ferry. The gear ratios are such that the scooter can reach speeds of a normal bicycle.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Step Scooter comprising:
a longitudinal support bar;
a resilient, approximately twelve inch diameter wheel attached by a shaft to a U shaped bracket to the back end of said longitudinal bar;
a resilient, approximately six inch diameter wheel attached to by a shaft to a steerable front fork to the front end of said longitudinal bar;
a hinged handle bar support tube;
a handle bar attached to said support tube;
a large approximately eight and one half inch diameter gear attached by a shaft to said longitudinal support bar;
a small approximately two and one half inch diameter gear attached to said shaft of said twelve inch wheel;
a drive chain attaching said small gear to said large gear;
a left and right drive disk, each centrally attached to said large gear shaft;
each said disk having a shaft protruding outwardly from near the perimeter of said disk;
a pair of step support bars, each attached to said perimeter disk shaft;
the end of each said step support bar terminating in a roller wheel;
a corresponding track for said roller wheel to travel in and a step platform attached to each said step support bar.

2. Step Scooter as claimed in claim 1 further comprising a three speed internal hub gear system within said twelve inch wheel.

3. Step Scooter as claimed in claim 1 further comprising a support stand for said twelve inch wheel and attached scooter that includes a rolling member that frictionally abuts the tire of said twelve inch wheel, said rolling member attached to a resistance means so that a user can use said step scooter as a stationary elliptical exercise machine.

4. Step Scooter as claimed in claim 1 wherein said handle bar support tube is hinged at a point just above said longitudinal support bar thereby allowing said handle bar tube to fold down for compact transport.

5. Step Scooter as claimed in claim 1 wherein the front end of said longitudinal support tube terminates in a hand gripping portion so that a person's hand may pull said scooter by said grip during periods of non use transit while said twelve inch wheel rolls on the ground,

6. Step Scooter as claimed in claim 1 wherein said handle bar portion can be easily removed and replaced so that said handle bars are not protruding outwards during compact transport.

7. Step Scooter as claimed in claim 1 wherein said roller wheels are prevented from escaping said tracks because the shafts of each said wheels extend to engage a slot in the side rail of said track.

8. Step Scooter as claimed in claim 1 wherein said relatively close lateral placement of said step support bars improves the ease and stability of riding said step scooter.
